(19) United States
(12) Patent Application Publication
(10) Pub. No.: US 2026/0004400 A1
(43) Pub. Date: Jan. 1, 2026

(54) SYSTEM AND METHOD FOR PERFORMING IMAGE ADJUSTMENTS

(71) Applicant: Beken Corporation, Shanghai (CN)

(72) Inventors: Jinyue HUO, Shanghai (CN); Long Chen, Shanghai (CN); Caogang Yu, Shanghai (CN); Anan Xie, Shanghai (CN); Longbao Hu, Shanghai (CN)

(73) Assignee: Beken Corporation, Shanghai (CN)

(21) Appl. No.: 18/795,870

(22) Filed: Aug. 6, 2024

(30) Foreign Application Priority Data
Jul. 1, 2024 (CN) 202410875871.1

(51) Int. Cl. G06T 3/606; G06V 10/82

(52) U.S. Cl. CPC G06T 3/606; G06V 10/82

(57) ABSTRACT

A method and apparatus for real-time image adjustment are disclosed, particularly suited for embedded systems with limited computing resources. The method involves selecting a target area within an image, partitioning this area into multiple portions, and utilizing a random access memory (RAM) to facilitate the rotation of each portion. The rotated portions are then assembled to form a complete, rotated target area, which is subsequently displayed on an image consumer device. This process is optimized for efficiency and speed, ensuring that high-definition images can be processed and oriented correctly in real time.

### CROSS-REFERENCE TO RELATED APPLICATIONS

This application claims priority to and incorporates by reference Chinese application no. 202410875871.1 filed 1 Jul. 2024.

### TECHNICAL FIELD

The technical field of the present disclosure generally relates to image processing, and more specifically, a system and method for rotating an image or a video in real-time.

### BACKGROUND

An image captured by a camera may need to be rotated so that the image is oriented properly such that a viewer of the image can see the image from the right angle. Image rotation is an operation that adjusts the orientation of an image.

Embedded systems are commonly seen in Internet-of-Things (IoTs) devices where cameras are installed in such embedded systems. Common IoTs include video doorbells, surveillance cameras, and other smart devices.

### BRIEF SUMMARY

A method for image adjustment involves selecting a target area of an image to be rotated, partitioning the target area into one or more portions, moving each portion to a source partition of a high-speed random access memory (HSRAM), rotating each portion by storing a plurality of pixels of each portion to a destination partition of the HSRAM, obtaining a rotated target area by assembling each rotated portion, and displaying the rotated target area in an image consumer.

In an embodiment, a computing apparatus is claimed, which includes one or more processors and one or more non-transitory hardware memory storing instructions that, when executed, configure the apparatus to perform operations comprising selecting a target area of an image to be rotated, partitioning the target area into one or more portions, moving each portion to a source partition of a high-speed random access memory (HSRAM), rotating each portion by storing a plurality of pixels of each portion to a destination partition of the HSRAM, obtaining a rotated target area by assembling each rotated portion, and displaying the rotated target area in an image consumer.

In another embodiment, a non-transitory computer-readable storage medium is claimed, containing instructions that, when executed by a computer, cause the computer to perform operations comprising selecting a target area of an image to be rotated, partitioning the target area into one or more portions, moving each portion to a source partition of a high-speed random access memory (HSRAM), rotating each portion by storing a plurality of pixels of each portion to a destination partition of the HSRAM, obtaining a rotated target area by assembling each rotated portion, and displaying the rotated target area in an image consumer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a network diagram illustrating a working environment 100 suitable for a computing system to perform image adjustment, according to some examples.

FIG. 2 is a block diagram illustrating some components of the computing system 102, as configured for image adjustment, according to some examples.

FIG. 3 is a conceptual diagram illustrating a target area 304 of the original image 302 and a rotated target area 306, according to some examples.

FIG. 4 is a conceptual diagram illustrating different stages of image adjustment, according to some examples.

FIG. 5 is a flowchart illustrating the image adjustment method 500, according to some examples.

FIG. 6 is a diagrammatic representation of the machine 600, according to some examples.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embedded systems have limited computing resources, so rotating an image (especially high-definition images) can be challenging with embedded systems. The present disclosure primarily elaborates on a method and systems that quickly adjust, rotate, and display images that are continuously outputted by one or more image producers, which may be devices with cameras.

A fast local rotation module in an embedded system, hereinafter referred to as the rotation component, partitions the image data into several portions (e.g., columns, rows, blocks, partitions), rotates each portion individually, and copies the rotated portions to the correct offset address in the target buffer. The fast rotation module also supports rotating a local area within the source image.

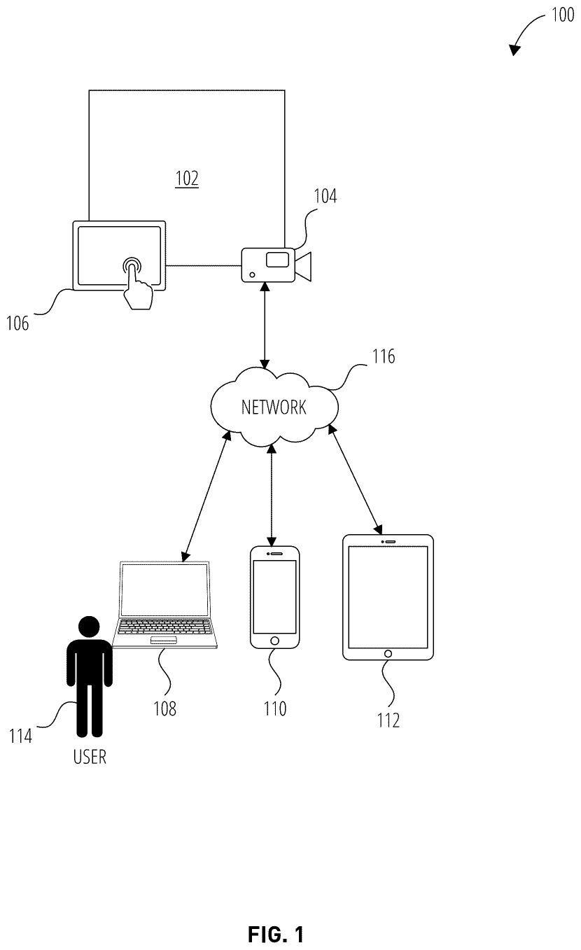

FIG. 1 is a network diagram illustrating a working environment 100 suitable for a computing system to perform image adjustment, according to some examples. In the example working environment 100 illustrated in FIG. 1, a computing system 102 comprises a camera 104 and a display 106. The computing system 102 is coupled to one or more connected devices via a network 116. The one or more devices may be a laptop 108, a cellphone 110, and/or a tablet 112.

In some examples, the working environment 100 may be an Internet of Things (IoT) environment, which functions by interconnecting various devices and appliances through a network, allowing them to communicate and share data. IoT devices, some of which may be equipped with sensors (e.g., camera 104), displays (e.g., display 106), software, and other technologies, can collect and exchange information, enabling them to operate semi-autonomously or with minimal human intervention. Devices such as laptops, cellphones, tablets, and other hand-held or wearable devices can be used to monitor and control other connected IoT devices remotely. The computing system 102 may be an IoT device.

For example, a user may use their smartphone to interact with their home's smart thermostat, adjusting temperature settings from afar. Similarly, a laptop could be used to access photo and/or video feeds from IoT devices such as security cameras or smart doorbells, or a tablet might control a network of smart lighting. The IoT ecosystem is designed to streamline processes and enhance convenience by integrating physical objects into the digital world, creating a network of smart, responsive devices that can adapt to user needs and environmental conditions.

Each of the one or more devices may include one or more cameras. The cameras may capture images and/or videos that need to be displayed in image consumers (e.g., displays, screens, or monitors). To be displayed, the image would need to fit the display, so image adjustment may need to be performed such that the adjusted image may be fitted to the display. In some examples, a video frame is referred to as an image.

In some examples, the computing system 102 is equipped with network communication capabilities, allowing it to connect to various types of devices over a network (e.g., network 116). The network can be a local area network (LAN), a wide area network (WAN), or the Internet, facilitating the transmission of data, including images and video, to remote devices.

In some examples, the computing system 102 includes a display 106 used to display image and/or video captured by camera 104 and/or cameras of the one or more devices. In these examples, when the image and/or video are captured, they may not have been oriented properly for displaying on display 106 (e.g., the computing system 102 is mounted upside-down, the user 114 captured an image in portrait/landscape mode), so the image and/or video captured need to be rotated.

On the other hand, image and/or video captured by camera 104 of the computing system 102 may be displayed on the screens of the one or more devices (e.g., laptop 108, cellphone 110, and tablet 112). In some examples, the image and/or video captured by camera 104 may be in an orientation in a way that does not fit the displays of the one or more devices, so the captured image and/or videos may be adjusted before it is outputted to the one or more devices for displaying.

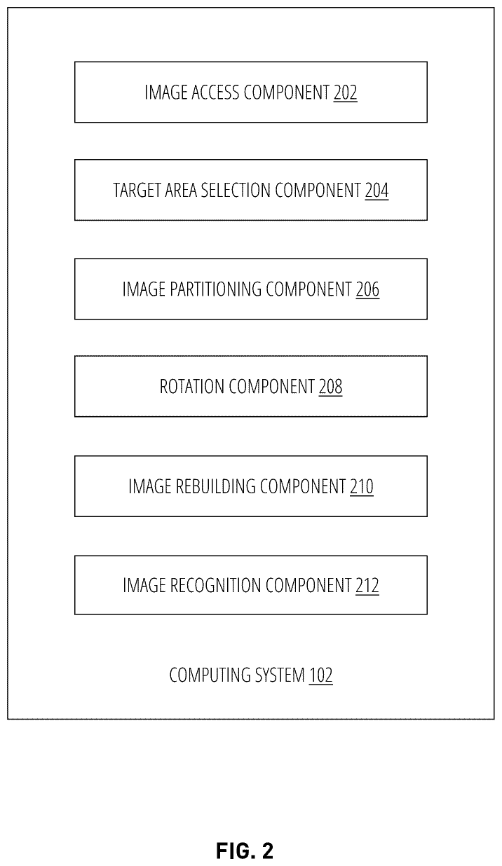

FIG. 2 is a block diagram illustrating some components of the computing system 102, as configured for image adjustment, according to some examples. The computing system 102 comprises of image access component 202, target area selection component 204, image partitioning component 206, rotation component 208, image rebuilding component 210, and image recognition component 212.

Image access component 202 accesses image captured by one or more image producers (e.g., camera 104 and/or cameras of the one or more connected devices). The access image may be stored in a first buffer.

Target area selection component 204 selects a target area of the image. In some examples, target area selection component 204 performs a cropping operation, which trims a captured image or video frames. In other examples, the cropping operation is optional; however, only the target area of the image undergoes additional processing.

Image partitioning component 206 partitions the target area of the image into one or more portions. The one or more portions may be moved (e.g., loaded, stored) into a high-speed random access memory (HSRAM) for further processing. Within the HSRAM, these portions may be rapidly accessed and subjected to the next stages of image processing, which may include operations such as rotation, scaling, or filtering.

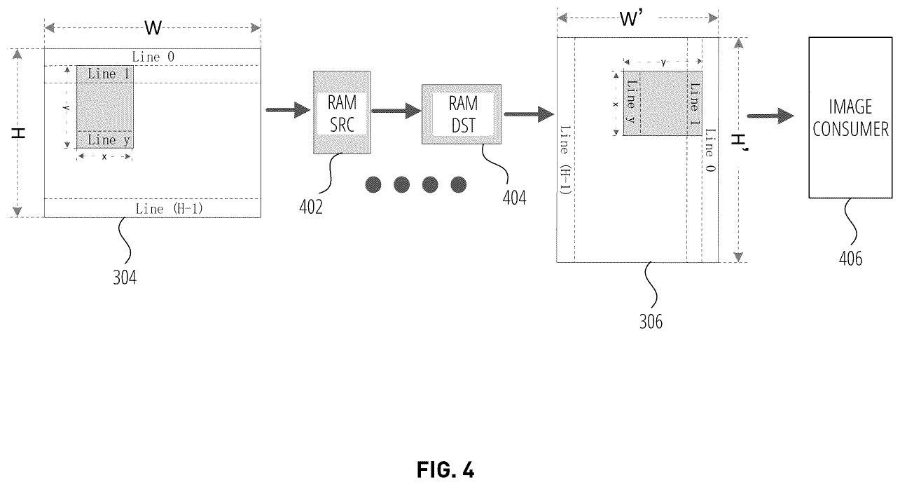

Rotation component 208 rotates the one or more portions of the image and/or video frames. Detailed operations will be described below with reference to FIG. 4.

Image rebuilding component 210 assembles the one or more rotated portions of the image back together. In some examples, image rebuilding component 210 writes a rotated portion in an appropriate location of a second buffer such that when all of the rotated portions are written to the second buffer, a rotated image would be stored in the second buffer ready for output. Note that a rotated image may be referred to as a rotated target area of the image.

Image recognition component 212 is an artificial intelligence (AI) component that can identify and classify objects, features, or patterns within an image. This component relies on machine learning algorithms, particularly convolutional neural networks (CNNs), which are designed to mimic the way the human brain processes visual information. Image recognition component 212 is trained using large datasets of labeled images to learn how to recognize various objects and elements within different contexts.

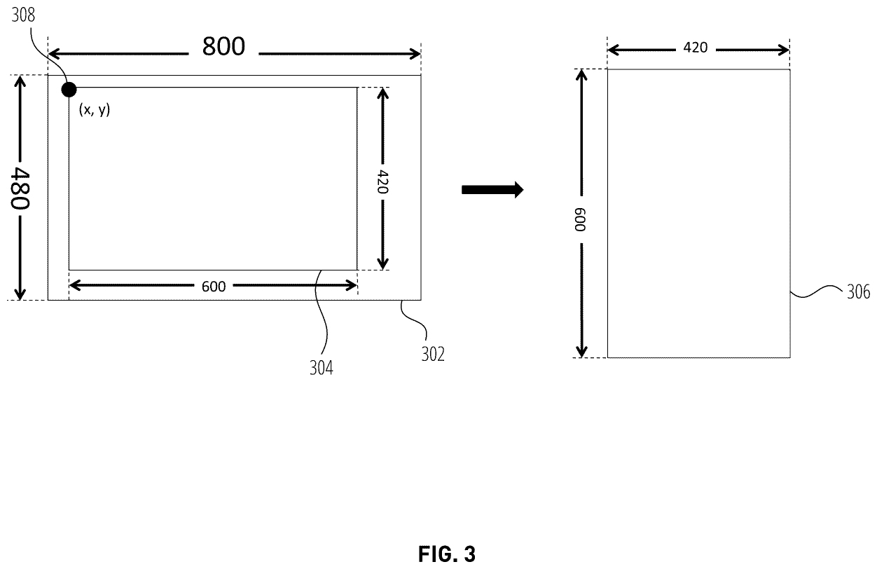

FIG. 3 is a conceptual diagram illustrating a target area 304 of the original image 302 and a rotated target area 306, according to some examples. The computing system 102 may select a target area (e.g., target area 304) within an original image 302 for performing the image adjustment to accommodate the different requirements (e.g., dimensions, orientation) of image consumers (e.g., display 106).

In some examples, a target area 304 has dimensions corresponding to the dimensions of an image consumer (e.g., display 106). In other words, the dimensions of the target area 304 may be matched to those of the image consumer. In some examples, a target area 304 of the original image 302 is automatically selected based on dimensions and an orientation of the image consumer.

In some other examples, a target area 304 of the original image 302 is selected automatically based on an image recognition result, wherein the image recognition result indicates one or more relevant area of the frame. The image recognition result refers to the output of the image recognition component 212. The relevant area of the image are specific areas that contain the subjects or objects of interest identified by the image recognition component 212. For example, if the computing system 102 is a smart doorbell, the image recognition component 212 might be trained to detect and recognize human figures. When a delivery person arrives at the doorstep, the system analyzes the camera feed, identifies the person, and determines the target area 304, which is the relevant area of the image where the person is located. This targeted approach enhances the performance of the image rotation process, ensuring a quick and accurate selection of content captured by the smart doorbell's camera.

In some examples, the target area 304 is the entire original image 302. In other words, the process of selecting a target area is optional.

In some examples, the original image 302, target area 304, and rotated target area 306 are image data in RGB 888 format. RGB 888 format is a way of encoding color information for digital images. In this format, each pixel in the image is represented by three separate color components-Red (R), Green (G), and Blue (B). Each of these components is allocated 8 bits (1 byte), thus giving the format its name “888”. Here's a breakdown of what this looks like: Red Component: 8 bits are used for the red component. This allows for 256 different shades of red, ranging from 0 (no red) to 255 (full red). Green Component: Similarly, 8 bits are used for the green component. This also allows for 256 shades, from 0 (no green) to 255 (full green). Blue Component: The blue component also uses 8 bits, allowing for 256 shades of blue, from 0 (no blue) to 255 (full blue). Therefore, each pixel in an RGB 888 image is represented by a combination of these three colors, with each color having 256 possible shades. The total number of colors that can be represented in this format is 256×256×256, which equals about 16.7 million different colors. In terms of actual data representation, a single pixel's color (e.g., color value) could be represented as a 24-bit number, with the first 8 bits representing red, the next 8 bits for green, and the last 8 bits for blue. For example, a pixel with a color of full red, no green, and full blue would be represented as 11111111 00000000 11111111 in binary, or FF 00 FF in hexadecimal.

The original image 302 in a first format may be converted to a second format. In some examples, the original image 302 is converted to a second format such as RGB888, RGB565, YUV 422, YUV 420, YUV 444, RGB565A, or RGBA8888 formats.

In the example illustrated in FIG. 3, the original image 302 has dimensions of 800 pixels×480 pixels; however, an image consumer 406 (e.g., display 106) is optimally suited for an image with dimensions of 420 pixels×600 pixels; therefore, a target area 304 with dimensions of 600 pixels×420 pixels is selected such that after a 90-degree rotation, the rotated target area 306 would better accommodate the dimensions and the orientation a display 106.

In some examples, the original image 302 is cropped to remove content outside of the target area 304 prior to rotation. In some other examples, the original image 302 undergoes a transformation process to become the target area 304 by employing methods such as scaling, where the image is resized to match the target area's dimensions, or perspective warping, which adjusts the image to fit a particular perspective or aspect ratio of the target area.

In some examples, the computing system 102 selects the target area 304 defined by original coordinates (e.g., original coordinates 308), a width of the target area 304, and a height of the target area 304. The original coordinates 308 represents a corner of the target area 304 (e.g., upper left corner). The original coordinates 308 may be coordinates represented by (x, y). In some examples, the top left corner of the original image 302 may have coordinates of (0, 0), and the top left corner of the target area may be (20, 10). The width of the target area 304 may be 600 pixels and the height of the target area 304 may be 420 pixels. Hence, the target area 304 is defined by four corner coordinates: upper left corner (20, 10), upper right corner (620, 10), bottom left corner (20, 430), and bottom right corner (620, 430). The units of the coordinates may be in pixels.

In other examples, the target area 304 may be of any shape such as oval, triangle, rectangle with rounded corners, or irregular shape. The shape and dimension of the target area may be determined by user input from a user (e.g., user 114), a shape of the image consumer 406, or a factory setting.

Note that the target area of the original image 302 may be selected after the rotation so that the original image 302 is rotated first using the method described herein. Then, the target area 304 is selected within a rotated original image 302 for outputting to an image consumer 406.

FIG. 4 is a conceptual diagram illustrating different stages of image adjustment, according to some examples. FIG. 4 illustrates a target area 304 of the original image 302, a RAM_SRC 402, a RAM_DST 404, a rotated target area 306, and an image consumer 406.

The target area 304 has a target area width of W (e.g., 600 pixels) and a target area height of H (e.g., 420 pixels). When the rotation of the target area 304 is complete, the rotated target area 306 will have a rotated target area width of W′ (e.g., 420 pixels) and a rotated target area height of H′ (e.g., 600 pixels).

The target area 304 may be partitioned into one or more portions. In some examples, each of the one or more portions has dimensions defined by a portion width (e.g., x) and a portion height (e.g., y). The one or more portions may be of different dimensions—the portions near the edges of the target area 304 may be smaller than other portions. For example, a first subset of the one or more portions has a first dimension and a second subset of the one or more portions has a second dimension. In this example, a majority of the image may be covered by the first subset of the one or more portions, and the spaces around the edges may be covered by the second subset of the one or more portions. In some examples, the target area width is a first integer multiple of the portion width, and the target area height is a second integer multiple of the portion height. Consider an example where the target area width is 600 pixels and the target area height is 400 pixels. If the portion width is set to 30 pixels and the portion height is set to 20 pixels, then target area width is 20 times (e.g., the first integer multiple) the portion width (600 pixels/30 pixels=20), and the target area height is also exactly 20 times (e.g., the second integer multiple) the portion height (400 pixels/20 pixels=20). Consequently, the entire target area can be evenly partitioned into portions without any remainder. In this example, the target area can be covered by 20 portions along its width and 20 portions along its height, resulting in a total of 400 portions. In other words, the whole target area 304 may be covered by the one or more portions having the same dimensions.

The shaded portion illustrated in FIG. 4 is an example portion of the one or more portions. The shaded portion includes y rows of pixels (i.e., from Line 1 to Line y), and each row includes x pixels. For simplicity of explanation, let's say y is 2 and x is 2 such that the shaded portion is a 2×2 pixel image. The two pixels in the first row (i.e., line 1) are FF 00 FF (a purple color) and 00 FF 00 (green), and the two pixels in the second row (i.e., line 2) are 00 00 FF (blue) and FF FF 00 (yellow).

In response to partitioning the target area 304 into one or more portions, the computing system 102 may repeatedly move (e.g., load, store) each of the one or more portions to an HSRAM until all of the one or more portions have been rotated. In some examples, the HSRAM comprises a source partition (e.g., RAM_SRC 402) and a destination partition (e.g., RAM_DST 404). The source partition stores one of the one or more portions to be rotated and the destination partition stores a rotated portion. In some examples, the two partitions of the HSRAM are two independent HSRAMs. HSRAMs may have three characteristics: higher frequencies, lower latencies, and more channels. For example, the HSRAM is a 6200 MHZ DDR5 HSRAM featuring 32 channels, allowing for substantial parallel data processing. As for latencies, the HSRAM could have a CAS Latency (CL) of 36 cycles, which at a frequency of 6200 MHz would translate to a real-time delay of approximately 5.81 nanoseconds per cycle, resulting in a total latency of around 209.16 nanoseconds for a single read operation. In some examples, the HSRAM comprises a tightly coupled memory (TCM). The TCM is directly connected to the processor core, providing ultra-low latency access and ensuring that the processor can retrieve information with minimal delay.

In some examples, a size of each of one or more portions is determined based on the capacity of the source partition and/or the destination partition. For example, the capacity of the source partition is 256 Megabit, so the size of each of the one or more portions is smaller or equal to 256 Megabit.

Moving each of the one or more portions to the source partition (e.g., RAM_SRC 402) may include storing the pixels using a row-major order in the source partition. Storing pixels in a row-major order means that the first row of the image is stored first, followed by the second row, and so on. For example, in a 3×3 image, the pixels of the first row are stored first, then the second row, and finally the third row. Using the example 2×2 pixel image mentioned above, the memory representation in the source partition may be as follows:
First Pixel (Purple): FF 00 FF
Second Pixel (Green): 00 FF 00
Third Pixel (Blue): 00 00 FF
Fourth Pixel (Yellow): FF FF 00

When a portion is loaded into the source partition/destination partition, each pixel's color can be accessed and modified individually. The linear arrangement of pixels means that the memory address of any specific pixel can be calculated if the dimensions of the image and the pixel's coordinates are known. This organization allows for efficient access and manipulation of the image data, as operations can be performed on a per-pixel basis or on larger sections of the image by moving through this linear sequence of color values.

In response to loading one of the portions into the source partition (e.g., RAM_SRC 402), the rotation component 208 begins the rotation process. The rotation of the portion involves mapping each pixel from its original position to a new position according to the rotation angle. For instance, a 90-degree rotation to the right (clockwise) would map the top-left pixel of the image to the top-right position of the rotated image. In some examples, the process involves calculating the new coordinates for each pixel using a rotation matrix corresponding to the desired angle of rotation.

The rotation matrix for a 90-degree clockwise rotation is:

$$\vert \begin{matrix}0 & - 1 \\ 1 & 0\end{matrix} \vert .$$

Applying the rotation matrix to the pixel coordinates, will swap the x and y values and invert the new y value to achieve the rotation. For the 2×2 pixel image, the pixel at position (0,0) would move to (0,1), and the pixel at (0,1) would move to (1,1), and so on. The new coordinates are then used to determine where to store the pixel's color values in the destination partition (e.g., RAM_DST 404).

More specifically, the rotation component 208 reads the color values of each pixel from RAM_SRC 402, applying the rotation matrix to calculate the new coordinates, and then writing the color values to the corresponding new location in RAM_DST 404. This process is repeated for each pixel in the portion until the entire portion has been rotated. After the rotation of a portion is complete, the rotated portion is stored in the destination partition (e.g., RAM_DST 404). The memory layout in RAM_DST 404 will differ from RAM_SRC 402 due to the rotation. For example, after a 90-degree clockwise rotation, the 2×2 pixel image would be stored in RAM_DST 404 as follows:
First Pixel (Blue): 00 00 FF
Second Pixel (Purple): FF 00 FF
Third Pixel (Yellow): FF FF 00
Fourth Pixel (Green): 00 FF 00

This new arrangement reflects the rotated positions of the pixels. The blue pixel, originally in the bottom-left position, is now in the top-left position, and so on.

The rotation component 208 may rotate the one or more portions by any angle, clockwise or counter-clockwise, by applying a general rotation matrix:

$$\vert \begin{matrix}cos ( θ ) & - sin ( θ ) \\ sin ( θ ) & cos ( θ )\end{matrix} \vert$$

to the pixel coordinates. θ may represent the angle of rotation, and a positive θ value may represent counter-clockwise rotations, while negative θ value represents clockwise rotations. When the general matrix is applied to the pixel coordinates, it calculates the new positions based on the angle of rotation, allowing for a smooth and continuous range of rotation angles. In response to calculating the new positions, the rotation component 208 writes the pixel's color values to those new positions in the destination memory (e.g., RAM_DST 404). This process is repeated for each pixel until the entire portion has been rotated to the desired orientation.

Once all of the pixels in a portion have been rotated and stored in the destination partition (e.g., RAM_DST 404), the rotated portion is moved to a second buffer, where the image rebuilding component 210 may assemble the rotated portions to form the rotated target area 306. This involves copying the rotated portion from RAM_DST 404 to the final destination, the second buffer, where the rotated target area 306 can be outputted to an image consumer 406. The image rebuilding component 210 takes into account the new coordinates of each rotated portions to ensure that the portions are placed correctly relative to each other, maintaining the integrity of the rotated target area 306.

The described rotation mechanism is highly efficient, allowing for high-speed image processing which is particularly beneficial in real-time applications such as video streaming, gaming, or any other scenario where images need to be rotated and displayed without perceptible delay. Nevertheless, the rotation component 208 may utilize alternative rotation mechanisms such as 1) Nearest Neighbor Interpolation, a method where the closest pixel's value is used for the new pixel value after rotation. It is fast but can result in a jagged or pixelated image, especially at larger rotation angles; 2) Bilinear Interpolation, a method that takes a weighted average of the four nearest pixels to determine the new pixel value, resulting in smoother images than nearest neighbor interpolation; 3) Affine Transformations: More complex than simple rotation matrices, affine transformations allow for rotation combined with scaling and translation, providing more flexibility in image manipulation; and 4) Fourier Transform Methods: By transforming the image into the frequency domain, rotations can be performed more efficiently for large images, though this method is more computationally intensive.

The use of HSRAM offers several technical benefits: 1) it ensures that the rotation process can keep up with the high data throughput requirements, providing smooth and responsive visual experiences; 2) HSRAM provides faster access times compared to dynamic RAM (DRAM), which is beneficial for real-time applications that aim for immediate data retrieval (e.g., from RAM_SRC 402) and storage (e.g., to RAM_DST 404). The high-speed nature of HSRAM allows for quick read and write operations, which is essential when processing large amounts of image data that need to be rotated and displayed rapidly; 3) HSRAM typically has a simpler control interface and does not require refresh cycles, which can lead to more predictable timing characteristics. This predictability is beneficial for maintaining the synchronization of image processing tasks, particularly in systems where timing precision is valued; 4) the static nature of HSRAM means that once data is written, it remains constant without the need for refresh, which can help in reducing power consumption for certain applications; and 5) HSRAM features a lower latency. This reduced latency contributes to the overall responsiveness of the system, as the delay between issuing a read or write command and the action being completed is minimized. In the context of image rotation, this means that each pixel or block of pixels can be accessed and modified with minimal delay, ensuring that the rotation can be completed within the tight time constraints of real-time applications.

In response to assembling the one or more rotated portions to obtain a rotated target area 306, the rotated target area 306 may be outputted from the second buffer for display (e.g., using an image consumer 406) and/or other processes. In response to generating a rotated target area, the computing system transmits the data comprising the rotated target area to the image consumers of the one or more connected devices via a network 116 through a network (e.g., network 116). The transmission involves packaging the rotated target area into a data format suitable for network transmission, ensuring data integrity and security during transit. In response to receiving the data, the remote device processes and displays the rotated target area. This process may involve additional steps such as decryption, decompression, and rendering the image on the device's display.

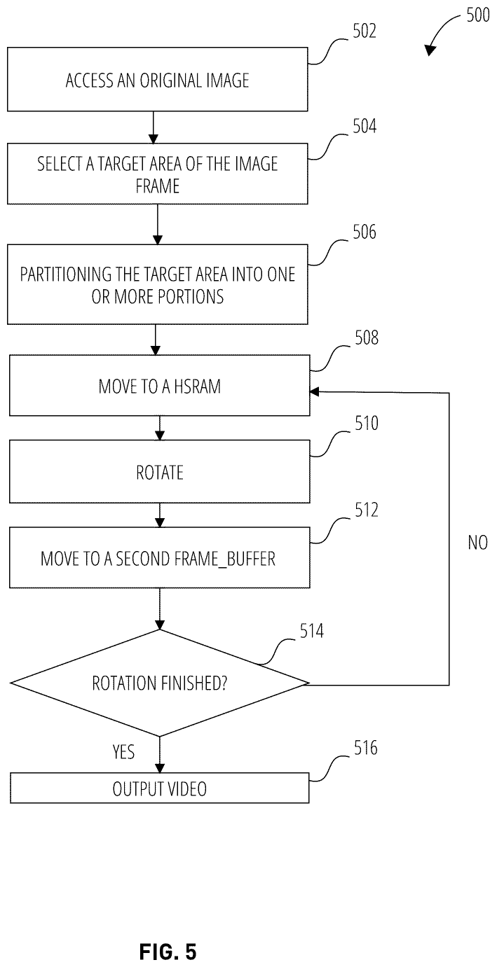

FIG. 5 is a flowchart illustrating the image adjustment method 500, according to some examples. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

At block 502, the computing system 102 accesses an original image (e.g., original image 302) from an image producer (e.g., camera 104, cameras on other electronic devices). The accessed original image may be stored in a first buffer.

At block 504, the computing system 102 selects a target area 304 within the original image 302 that needs to be rotated. The selection may be performed in the first buffer.

At block 506, the computing system 102 partitions the target area 304 into one or more portions based on a capacity of a partition of a HSRAM (e.g., RAM_SRC 402).

At block 508, the computing system 102 moves each of the one or more portions of the target area 304 to a source partition of the high-speed random access memory (HSRAM) (e.g., RAM_SRC 402) from the first buffer. In some examples, the process described in block 506, which involve partitioning the target area of the image into one or more portions, and block 508, which involves moving each portion to the HSRAM, can be executed concurrently. This means that the partitioning and moving of the portion may occur at substantially the same time.

At block 510, the computing system 102 rotates the portion(s) loaded onto the source partition of the HSRAM (e.g., RAM_SRC 402) using the method(s) described with reference to FIG. 4. Rotated pixels of the portion(s) may be stored in a destination partition of the HSRAM (e.g., RAM_DST 404). When the rotation process is complete, the destination partition (e.g., RAM_DST 404) will include the rotated portion(s).

At block 512, the computing system 102 moves the rotated portion(s) to a second buffer where the rotated portion(s) are assembled back together.

At decision block 514, the computing system 102 may check whether all of the one or more portions have been rotated. In some examples, the computing system 102 detects whether the first buffer is empty, indicating that all of the one or more portions have been rotated. In response to the rotation process has finished, the computing system 102 proceeds to block 516. If the rotation process has not finished (i.e., there are portions that have not been rotated), the computing system 102 proceeds to block 508 to move a next portion of the one or more portions of the target area 304 to the source partition of the HSRAM.

At block 516, the computing system 102 outputs the rotated frame to an image consumer (e.g., image consumer 406).

In some examples, where the original image (e.g., original image 302) is a video frame, blocks 506-516 are repeated for one or more frames in the video, treating the one or more frames as an image. Selecting a target area for subsequent frames (i.e., frames in a video succeeding the rotated frame) is unnecessary because the computing system 102 may use the same target area for subsequent frames.

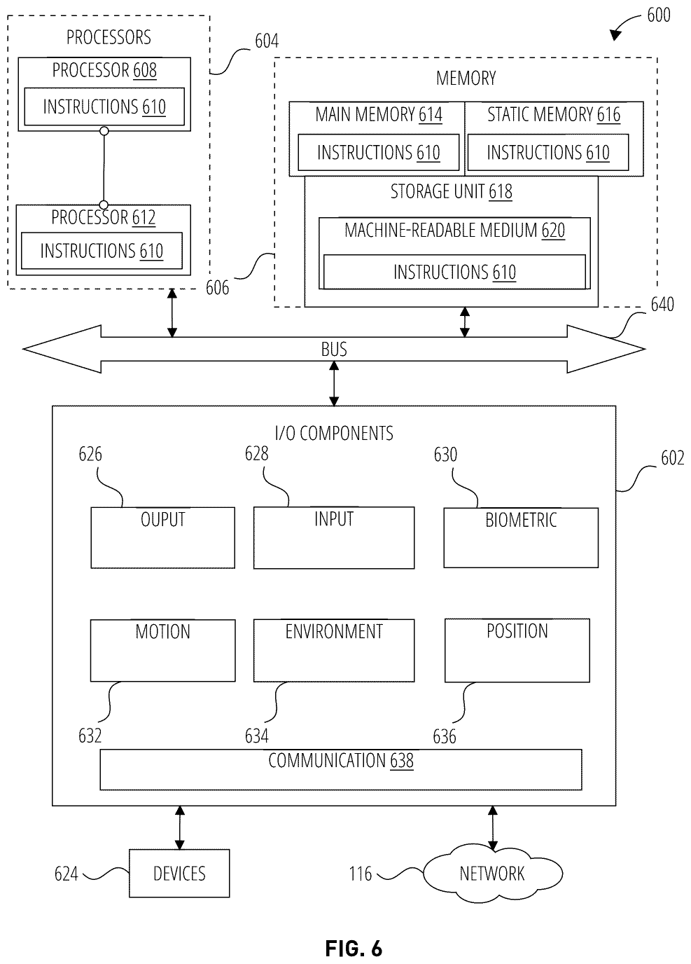

FIG. 6 is a diagrammatic representation of the machine 600 within which instructions 610 (e.g., software, a program, an application, an applet, an app, or other executable code) for causing the machine 600 to perform any one or more of the methodologies discussed herein may be executed. For example, the instructions 610 may cause the machine 600 to execute any one or more of the methods described herein. The instructions 610 transform the general, non-programmed machine 600 into a particular machine 600 programmed to carry out the described and illustrated functions in the manner described. The computing system 102 may be a machine 600, which may be referred to as a computer apparatus and operate as a standalone device or be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 610, sequentially or otherwise, that specify actions to be taken by the machine 600. Further, while a single machine 600 is illustrated, the term “machine” may include a collection of machines that individually or jointly execute the instructions 610 to perform any one or more of the methodologies discussed herein.

The machine 600 may include processors 604, memory 606, and I/O components 602, which may be configured to communicate via a bus 640. In some examples, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 608 and a Processor 612 that execute the instructions 610. The term “Processor” is intended to include multi-core processors that may comprise two or more independent processors (sometimes referred to as “cores”) that may execute instructions contemporaneously. Although FIG. 6 shows multiple processors 604, the machine 600 may include a single processor with a single core, a single processor with multiple cores (e.g., a multi-core processor), multiple processors with a single core, multiple processors with multiples cores, or any combination thereof.

The memory 606 includes a main memory 614, a static memory 616, and a storage unit 618, both accessible to the processors 604 via the bus 640. The main memory 614, the static memory 616, and storage unit 618 store the instructions 610 embodying any one or more of the methodologies or functions described herein. The instructions 610 may also reside, wholly or partially, within the main memory 614, within the static memory 616, within a hardware non-transitory computer-readable medium (e.g., machine-readable medium 620) within the storage unit 618, within the processors 604 (e.g., within the processor's cache memory), or any suitable combination thereof, during execution thereof by the machine 600.

The I/O components 602 may include various components to receive input, provide output, produce output, transmit information, exchange information, or capture measurements. The specific I/O components 602 included in a particular machine depend on the type of machine. For example, portable machines such as mobile phones may include a touch input device or other such input mechanisms, while a headless server machine will likely not include such a touch input device. The I/O components 602 may include many other components not shown in FIG. 6. In various examples, the I/O components 602 may include output components 626 and input components 628. The output components 626 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 628 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 602 may include biometric components 630, motion components 632, environmental components 634, or position components 636, among a wide array of other components. For example, the biometric components 630 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 632 include acceleration sensor components (e.g., accelerometer), gravitation sensor components, rotation sensor components (e.g., gyroscope). The environmental components 634 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 636 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 602 further include communication components 638 operable to couple the machine 600 to a network 116 or devices 624 via respective coupling or connections. For example, the communication components 638 may include a network interface Component or another suitable device to interface with the network 116. In further examples, the communication components 638 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 624 may be another machine or any of a wide variety of peripheral devices (e.g., a peripheral device coupled via a USB).

Moreover, the communication components 638 may detect identifiers or include components operable to detect identifiers. For example, the communication components 638 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 638, such as location via Internet Protocol (IP) geolocation, location via Wi-Fi® signal triangulation, or location via detecting an NFC beacon signal that may indicate a particular location.

The various memories (e.g., main memory 614, static memory 616, and/or memory of the processors 604) and/or storage unit 618 may store one or more sets of instructions and data structures (e.g., software) embodying or used by any one or more of the methodologies or functions described herein. These instructions (e.g., the instructions 610), when executed by processors 604, cause various operations to implement the disclosed examples.

The instructions 610 may be transmitted or received over the network 116, using a transmission medium, via a network interface device (e.g., a network interface component included in the communication components 638) and using any one of several well-known transfer protocols (e.g., hypertext transfer protocol (HTTP)). Similarly, the instructions 610 may be transmitted or received using a transmission medium via a coupling (e.g., a peer-to-peer coupling) to the devices 624.

### Examples

Example 1 is a method for image adjustment, comprising: capturing, by one or more cameras of a computing apparatus, an image of an environment; storing the image in a non-transitory hardware memory, the non-transitory hardware memory having a first capacity and a first read and write speed; receiving a selection of a target area of the image; partitioning the target area of the image into a plurality of portions; storing each portion of the plurality of portions to a source partition of a high-speed random access memory (HSRAM), the HSRAM having a second capacity and a second read and write speed, the second capacity being smaller than the first capacity and the second read and write speed being faster than the first read and write speed, wherein the each portion has a size smaller than a size of the source partition and the each portion comprises a plurality of pixels; determining an angle of rotation; determining a rotation matrix based on the angle of rotation; calculating new coordinates for the plurality of pixels by applying the rotation matrix to original coordinates of the plurality of pixels; calculating new locations in a destination partition of the HSRAM for the plurality of pixels based on the new coordinates; storing each of the plurality of pixels to each of the new locations of the destination partition, the plurality of pixels stored in the new locations in the destination partition corresponding to a rotated portion; generating a rotated target area by assembling the each rotated portion in the non-transitory hardware memory; and transmitting the rotated target area to an image consumer to cause a display of the rotated target area at the image consumer.
In Example 2, the subject matter of Example 1 includes, wherein: the target area of the image is selected automatically based on an image recognition result, wherein the image recognition result indicates one or more relevant areas of the image.
In Example 3, the subject matter of Examples 1-2 includes, wherein: the image recognition result is generated using a convolutional neural network (CNN) trained to process the image to identify patterns consistent with human figures and to output the image recognition result comprising coordinates defining the one or more relevant areas comprising the human figures within the image; and the target area is selected based on the coordinates generated by the CNN.
In Example 4, the subject matter of Examples 1-3 includes, wherein: partitioning the target area of the image into one or more portions in a first buffer of the non-transitory hardware memory; and obtaining the rotated target area by assembling the each rotated portion in a second buffer of the non-transitory hardware memory.
In Example 5, the subject matter of Examples 1˜4 includes, wherein: the target area comprises a target area width and a target area height; dimensions of each of the plurality of portions is defined by a portion height and a portion width; the target area width being a first integer multiple of the portion width; and the target area height being a second integer multiple of the portion height.
In Example 6, the subject matter of Examples 1-5 includes, wherein the plurality of portions comprising a first subset and a second subset, the first subset and the second subset having different dimensions.
In Example 7, the subject matter of Examples 1-6 includes, wherein the image is of a first format and the method further comprises: converting the first format of the image to a second format, wherein the second format is selected from at least one of RGB565, RGB888, and YUV422.
In Example 8, the subject matter of Examples 1-7 includes, wherein the image is a frame among a plurality of frames in a video, and the method further comprises: generating a plurality of rotated target areas corresponding to the plurality of frames in the video.
In Example 9, the subject matter of Examples 1-8 includes, wherein the target area of the image is selected automatically based on dimensions of the image consumer and an orientation of the image consumer.
In Example 10, the subject matter of Examples 1-9 includes, wherein the transmitting of the rotated target area to the image consumer includes sending the rotated target area over a network to a remote device, the remote device comprising at least one of a laptop, a cellphone, and a tablet, and wherein the remote device is configured to display the rotated target area to a user.
Example 11 is at least one machine-readable medium including instructions that, when executed by processing circuitry, cause the processing circuitry to perform operations to implement of any of Examples 1-10.
Example 12 is an apparatus comprising means to implement of any of Examples 1-10.
Example 13 is a system to implement of any of Examples 1-10.

In conclusion, the detailed description provided herein presents a system and method for real-time image adjustments (e.g., rotating, resizing, scaling videos and/or images). The embodiments disclosed offer a robust solution to the challenges associated with image processing in embedded systems, particularly within the context of Internet-of-Things (IoT) devices. The innovative use of high-speed random access memory (HSRAM) to facilitate the rapid rotation of image data ensures that high-definition images can be adjusted and displayed promptly, catering to the dynamic needs of modern smart devices and applications.

The disclosed embodiments are not intended to be exhaustive or to limit the invention to the precise form disclosed. It is to be understood that the invention can be practiced with modification and alteration within the spirit and scope of the appended claims. Accordingly, the foregoing description is intended to be illustrative, but not limiting, of the scope of the invention which is set forth in the following claims.

What is claimed is:

1. A method for image adjustment, comprising:
capturing, by one or more cameras of a computing apparatus, an image of an environment;
storing the image in a non-transitory hardware memory, the non-transitory hardware memory having a first capacity and a first read and write speed;
receiving a selection of a target area of the image;
partitioning the target area of the image into a plurality of portions;
storing each portion of the plurality of portions to a source partition of a random access memory (RAM), the RAM having a second capacity and a second read and write speed, the second capacity being smaller than the first capacity and the second read and write speed being faster than the first read and write speed, wherein the each portion has a size smaller than a size of the source partition and the each portion comprises a plurality of pixels;
determining an angle of rotation;
determining a rotation matrix based on the angle of rotation;
calculating new coordinates for the plurality of pixels by applying the rotation matrix to original coordinates of the plurality of pixels;
calculating new locations in a destination partition of the RAM for the plurality of pixels based on the new coordinates;
storing each of the plurality of pixels to each of the new locations of the destination partition, the plurality of pixels stored in the new locations in the destination partition corresponding to a rotated portion;
generating a rotated target area by assembling the each rotated portion in the non-transitory hardware memory; and
transmitting the rotated target area to an image consumer to cause a display of the rotated target area at the image consumer.

2. The method for image adjustment of claim 1, wherein the target area of the image is selected automatically based on an image recognition result, wherein the image recognition result indicates one or more relevant areas of the image.

3. The method for image adjustment of claim 2, wherein:
the image recognition result is generated using a convolutional neural network (CNN) trained to process the image to identify patterns consistent with human figures and to output the image recognition result comprising coordinates defining the one or more relevant areas comprising the human figures within the image; and
the target area is selected based on the coordinates generated by the CNN.

4. The method for image adjustment of claim 1, wherein:
partitioning the target area of the image into one or more portions in a first buffer of the non-transitory hardware memory; and
obtaining the rotated target area by assembling the each rotated portion in a second buffer of the non-transitory hardware memory.

5. The method for image adjustment of claim 1, wherein:
the target area comprises a target area width and a target area height;
dimensions of each of the plurality of portions is defined by a portion height and a portion width;
the target area width being a first integer multiple of the portion width; and
the target area height being a second integer multiple of the portion height.

6. The method for image adjustment of claim 1, wherein the plurality of portions comprising a first subset and a second subset, the first subset and the second subset having different dimensions.

7. The method for image adjustment of claim 1, wherein the image is of a first format and the method further comprises:
converting the first format of the image to a second format, wherein the second format is selected from at least one of RGB565, RGB888, and YUV422.

8. The method for image adjustment of claim 1, wherein the image is a frame among a plurality of frames in a video, and the method further comprises:
generating a plurality of rotated target areas corresponding to the plurality of frames in the video.

9. The method for image adjustment of claim 1, wherein the target area of the image is selected automatically based on dimensions of the image consumer and an orientation of the image consumer.

10. The method for image adjustment of claim 1, wherein the transmitting of the rotated target area to the image consumer includes sending the rotated target area over a network to a remote device, the remote device comprising at least one of a laptop, a cellphone, and a tablet, and wherein the remote device is configured to display the rotated target area to a user.

11. A computing apparatus comprising:
one or more cameras;
one or more processors;
a non-transitory hardware memory, the non-transitory hardware memory having a first capacity and a first read and write speed; and
a random access memory (RAM), the RAM having a second capacity and a second read and write speed, the second capacity being smaller than the first capacity and the second read and write speed being faster than the first read and write speed, wherein the non-transitory hardware memory storing instructions that, when executed by the one or more processors, cause the computing apparatus to perform operations comprising:
capturing, by the one or more cameras, an image of an environment;
receiving a selection of a target area of the image;
partitioning the target area of the image into a plurality of portions;
storing each portion of the plurality of portions to a source partition of the RAM, wherein the each portion has a size smaller than a size of the source partition and the each portion comprises a plurality of pixels;
determining an angle of rotation;
determining a rotation matrix based on the angle of rotation;
calculating new coordinates for the plurality of pixels by applying the rotation matrix to original coordinates of the plurality of pixels;
calculating new locations in a destination partition of the RAM for the plurality of pixels based on the new coordinates;
storing each of the plurality of pixels to each of the new locations in the destination partition, the plurality of pixels stored in the new locations in the destination partition corresponding to a rotated portion;
generating a rotated target area by assembling the each rotated portion in the non-transitory hardware memory; and
transmitting the rotated target area to an image consumer to cause a display of the rotated target area at the image consumer.

12. The computing apparatus of claim 11, wherein the target area of the image is selected automatically based on an image recognition result, wherein the image recognition result indicates one or more relevant areas of the image.

13. The computing apparatus of claim 12, wherein:
the image recognition result is generated using a convolutional neural network (CNN) trained to process the image to identify patterns consistent with human figures and to output the image recognition result comprising coordinates defining the one or more relevant areas comprising the human figures within the image; and
the target area is selected based on the coordinates generated by the CNN.

14. The computing apparatus of claim 11, wherein:
partitioning the target area of the image into one or more portions in a first buffer; and
obtaining the rotated target area by assembling the each rotated portion in a second buffer.

15. The computing apparatus of claim 11, wherein:
the target area comprises a target area width and a target area height;
dimensions of each of the one or more portions is defined by a portion height and a portion width;
the target area width being a first integer multiple of the portion width; and
the target area height being a second integer multiple of the portion height.

16. The computing apparatus of claim 11, wherein the one or more portions comprising a first subset and a second subset, the first subset and the second subset having different dimensions.

17. The computing apparatus of claim 11, wherein the image is of a first format and the operations further comprises:
converting the first format of the image to a second format, wherein the second format is selected from at least one of RGB565, RGB888, and YUV422.

18. The computing apparatus of claim 11, wherein the image is a frame among a plurality of frames in a video, and the operations further comprises:
generating a plurality of rotated target areas corresponding to the plurality of frames in the video.

19. The computing apparatus of claim 11, wherein the target area of the image is selected automatically based on dimensions of the image consumer and an orientation of the image consumer.

20. A non-transitory computer-readable storage medium, the computer-readable storage medium including instructions that when executed by a computing apparatus, cause the computing apparatus to performing operations comprising:
capturing, by one or more cameras of the computing apparatus, an image of an environment;
storing the image in a non-transitory hardware memory, the non-transitory hardware memory having a first capacity and a first read and write speed;
receiving a selection of a target area of the image;
partitioning the target area of the image into a plurality of portions;
storing each portion of the plurality of portions to a source partition of a random access memory (RAM), the RAM having a second capacity and a second read and write speed, the second capacity being smaller than the first capacity and the second read and write speed being faster than the first read and write speed, wherein the each portion has a size smaller than a size of the source partition and the each portion comprises a plurality of pixels;
determining an angle of rotation;
determining a rotation matrix based on the angle of rotation;
calculating new coordinates for the plurality of pixels by applying the rotation matrix to original coordinates of the plurality of pixels;
calculating new locations in a destination partition of the RAM for the plurality of pixels based on the new coordinates;
storing each of the plurality of pixels to each of the new locations in the destination partition, the plurality of pixels stored in the new locations of the destination partition corresponding to a rotated portion;
generating a rotated target area by assembling the each rotated portion in the non-transitory hardware memory; and
transmitting the rotated target area to an image consumer to cause a display of the rotated target area at the image consumer.
